(19) United States
(12) Patent Application Publication
(10) Pub. No.: US 2015/0370906 A1
(43) Pub. Date: Dec. 24, 2015

(54) SYSTEM AND METHOD FOR MAPPING IDENTIFIER WITH LOCATOR USING BLOOM FILTER

(71) Applicant: ELECTRONICS AND TELECOMMUNICATIONS RESEARCH INSTITUTE, Daejeon (KR)

(72) Inventors: Jung-Ha HONG, Daejeon (KR); Woo-Jik CHUN, Seoul (KR)

(21) Appl. No.: 14/691,029

(22) Filed: Apr. 20, 2015

(30) Foreign Application Priority Data
Jun. 18, 2014 (KR) 10-2014-0074378

(51) Int. Cl. G06F 17/30; G06F 7/36

(52) U.S. Cl. CPC G06F 17/30867; G06F 7/36

(57) ABSTRACT

The present invention relates to a mapping system that searches for locator information for an identifier by use of an autonomous system number (ASN) and a bloom filter (BF), a method for registering identifier/locator information in the mapping system and a method for searching for the locator information for the identifier in the mapping system. The system for mapping an identifier with a locator based on a bloom filter includes: bloom filter servers (BFSs) connected with one another in a tree structure and an identifier/locator mapping table associated with each of leaf BFSs located at a lower end of the tree structure. Each of the leaf BFSs includes a bloom filter indicating identifier information that is stored in the identifier/locator mapping table associated with the leaf BFS, and each of remaining BFS, except for the leaf BFSs, includes a bloom filter for a child BFS.

### CROSS-REFERENCE TO RELATED APPLICATIONS

This application claims the benefit of Korean Patent Application No. 10-2014-0074378, filed with the Korean Intellectual Property Office on Jun. 18, 2014, the disclosure of which is incorporated herein by reference in its entirety.

### BACKGROUND

1. Technical Field

The present invention relates to a system and a method for mapping an identifier with a locator, more specifically to a mapping system that can search for locator information for an identifier more efficiently by use of an autonomous system number (ASN) and a bloom filter (BF), a method for registering identifier/locator information in the mapping system and a method for searching for the locator information for the identifier in the mapping system.

2. Background Art

The Internet of today has serious extendibility problems for routing and addressing. The biggest causes for the extendibility problems are multi-homing, traffic engineering, unintegrated address assignment, etc. that result in an exponential increase in the size of a routing table in the backbone area. Moreover, since the IP addresses currently represent both the identifier and the locator of the host, there are limitations to supporting the mobility of the host and the multi-homing.

To address these problems of today's Internet, studies have been made for a structure in which the identifier is separated from the locator. In the structure of separated identifier and locator, since the identifier no longer includes network topology information, locator information of a counterpart, with whom communication is to be made, needs to be searched when packets are transmitted. In other words, it is essential that the structure of separated identifier and locator have a mapping system that plays the role of storing and managing the identifier of a node and the precise locator information mapped to the identifier.

However, such a mapping system may suffer with a bottleneck problem of the network due to a signaling overhead caused by a locator update. Accordingly, designing an effective mapping system is important for the structure of separated identifier and locator.

### SUMMARY

Exemplary embodiments of the present invention provide a mapping system that can effectively search for a precise current locator of a given identifier by use of a bloom filter in a structure of separated identifier and locator.

Moreover, the present invention provides a method of registering identifier/locator information in the mapping system using the bloom filter.

Furthermore, the present invention provides a method of searching for a locator for an identifier in the mapping system using the bloom filter.

An aspect of the present invention features a system for mapping an identifier with a locator based on a bloom filter. The system for mapping an identifier with a locator based on a bloom filter in accordance with an embodiment of the present invention includes: a plurality of bloom filter servers (BFSs) connected with one another in a tree structure; and an identifier/locator mapping table associated with each of a plurality of leaf BFSs located at a lower end of the tree structure. Each of the leaf BFSs includes a bloom filter indicating identifier information that is stored in the identifier/locator mapping table associated with the leaf BFS, and each of remaining BFS, except for the leaf BFSs, includes a bloom filter for a child BFS. Once a locator query message for an identifier is received, a parent BFS recursively searches the bloom filter for the child BFS and transfers the locator query message to the leaf BFS associated with the identifier/locator mapping table having locator information for the identifier stored therein.

In an embodiment, the system can be generated for each of autonomous system (AS) domains.

In an embodiment, the locator query message for the identifier can be initially received by a root BFS of the tree structure from a router.

Another aspect of the present invention features a method of registering an identifier and a locator in a system for mapping an identifier with a locator based on a bloom filter. The method is carried out in a system including a plurality of bloom filter servers (BFSs) connected with one another in a tree structure and an identifier/locator mapping table associated with each of a plurality of leaf BFSs located at a lower end of the tree structure. The method of registering an identifier and a locator in a system for mapping an identifier with a locator based on a bloom filter in accordance with an embodiment of the present invention includes: registering an identifier and a locator corresponding to the identifier in a designated identifier/locator mapping table; calculating a bloom filter (BF) value for the identifier and updating a BF value of a leaf BFS associated with the identifier/locator mapping table; and updating a BF value of a parent BFS recursively according to the updated BF value of the leaf BFS until a BF value of a root BFS is updated.

The method of registering an identifier and a locator in a system for mapping an identifier with a locator based on a bloom filter, carried out in a system including a plurality of bloom filter servers (BFSs) connected with one another in a tree structure and an identifier/locator mapping table associated with each of a plurality of leaf BFSs located at a lower end of the tree structure, in accordance with another embodiment of the present invention includes: receiving a locator query message querying about a locator of an identifier from a router, the locator query message being received by a root BFS of the tree structure; calculating a bloom filter value of the identifier, the bloom filter value being, calculated by the root BFS having received the locator query message; transferring the locator query message by searching a child BFS having the calculated bloom filter value; transferring a reply message having locator information for the identifier included therein to a parent BFS from the child BFS having the calculated bloom filter value; and receiving the reply message and transferring the reply message to the router, the reply message being received and transferred by the root BFS.

The system for mapping an identifier with a locator based on a bloom filter can be generated for each of autonomous system (AS) domains.

The method can further include obtaining an autonomous system number (ASN) included in a header of the identifier and transferring the locator query message to a mapping system corresponding to the ASN, the ASN being obtained and the locator query message being transferred by the router.

The step of transferring the locator query message by searching a child BFS having the calculated bloom filter value can be recursively carried out until the locator query message is transferred to a leaf BFS having the bloom filter value.

Once the locator query message is transferred to the leaf BFS having the bloom filter value, the leaf BFS can search an identifier/locator mapping table associated therewith and obtain locator information corresponding to the identifier.

The step of transferring a reply message having locator information for the identifier included therein to a parent BFS from the child BFS having the calculated bloom filter value can be recursively carried, out until the reply message is transferred to the root BFS.

According to the mapping system suggested by the present invention, it is possible to improve the speed of searching, the mapping between the identifier and the locator. It is also possible to effectively minimize a lowered search capability caused by an, increase in the number of identifiers.

Moreover, the structure of the mapping system is not, changed even if location information registered for the identifier is changed, and mapping table information of the mapping server having the location information of the pertinent identifier needs to be only changed. Therefore, the mapping system can be readily managed, and mobility can be readily supported.

### BRIEF DESCRIPTION OF THE DRAWINGS

FIG. 1 illustrates the structure of a system for mapping an identifier with a locator by use of a bloom filter in accordance with an embodiment of the present invention.

FIG. 2 illustrates an example of an identifier/locator mapping table.

FIG. 3 is a flow diagram showing how an identifier and a locator are registered in accordance with an embodiment of the present invention.

FIG. 4 is a flow diagram illustrating the steps for searching for a locator in accordance with an embodiment of the present invention.

FIG. 5 is a block diagram showing the configuration of a computing system for realizing a BFS server constituting the mapping system of the present invention.

### DETAILED DESCRIPTION

Since there can be a variety of permutations and embodiments of the present invention, certain embodiments will be illustrated and described with reference to the accompanying drawings. This, however, is by no means to restrict the present invention to certain embodiments, and shall be construed as including all permutations, equivalents and substitutes covered by the ideas and scope of the present invention.

Throughout the description of the present invention, when describing a certain relevant conventional technology is determined to evade the point of the present invention, the pertinent detailed description will be omitted.

Unless clearly used otherwise, expressions in a singular form in the description and in the claims shall be interpreted to generally mean “one or more.”

Terms such as “module,” “unit,” “interface,” etc. shall generally mean computer-related objects, for example, hardware, software, and/or a combination thereof.

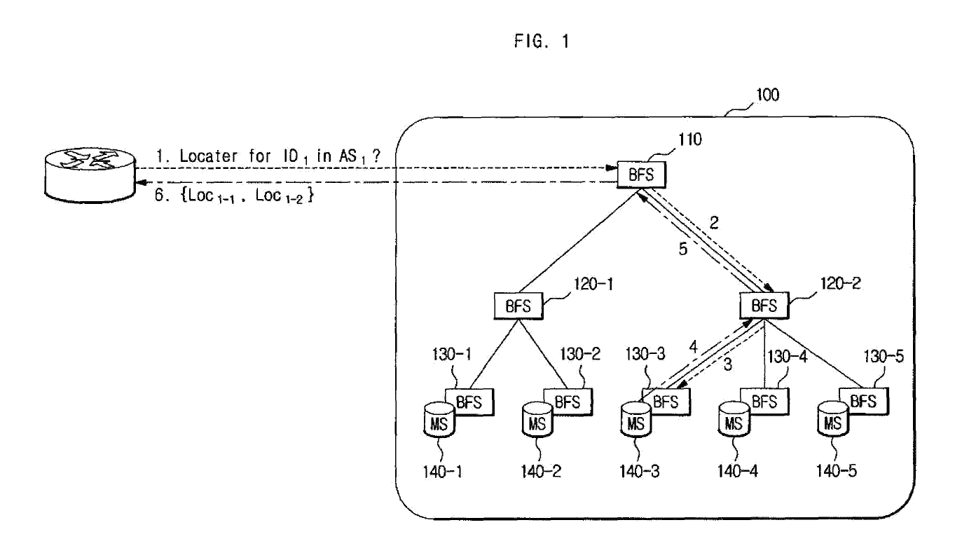

Hereinafter, certain embodiments of the present invention will be described with reference to FIG. 1 to FIG. 5.

FIG. 1 illustrates the structure of a system for mapping an identifier with a locator by use of a bloom filter in accordance with an embodiment of the present invention. A mapping system 100 may be configured for each autonomous system (AS) domain.

A bloom filter (BF), which is a data structure for expressing information on membership of elements belonging to a particular group as a simple bit-vector, is commonly used as a pre-filter for determining whether a particular input value corresponds an element belonging to a group.

As illustrated, the mapping system 100 includes a plurality of bloom filter servers (BFSs) that are connected with one another in a tree structure. Each of the BFSs 110, 120-1, 120-2, except for leaf BFSs located at a lower end of the BFS tree, includes its own child BF, and each of the leaf BFSs includes a mapping table 140-1, 140-2, 140-3, 140-4, 140-5, in which mapping information of an identifier and a locator is stored, in addition to its own bloom filter. Although the mapping system 100 of FIG. 1 shows 3 levels of tree constituted with 8 BFSs therein, this is only an example used for illustration, and the structure of the mapping system in accordance with the present invention shall not be limited to what is illustrated herein.

Moreover, depending on the embodiment, the mapping table may be provided as a server that is physically independent from the BFS, and this or any modification of the embodiment shall be also included in the scope of the present invention.

According to the mapping system 100 shown in FIG. 1, by sending a query about a locator of an identifier to a root BFS 110 in a mapping system of a specific domain in order to check the locator of the identifier belonging to the specific domain, it is possible to find out which of the child BFSs has location information of the identifier being searched for by recursively searching its child bloom filters.

The identifier to be searched fords presumed to be a flat address, rather than an IP address. Here, the address is referred to be flat if the address of the identifier has no information when packets are being forwarded or routed.

In an embodiment of the present invention, the identifier can include an autonomous system number (ASN) in a header thereof. For example, supposing that the mapping system shown in FIG. 1 is for domain AS₁, when a query about a locator for an identifier included in the domain AS₁ is initially received by the, root BFS 110, the query is transferred to BFS 130-3 by way of BFS 120-2 through a bloom filter search, and, the BFS 130-3 searches the mapping table 140-3 related thereto and replies with a reply message having locator information for the identifier included therein.

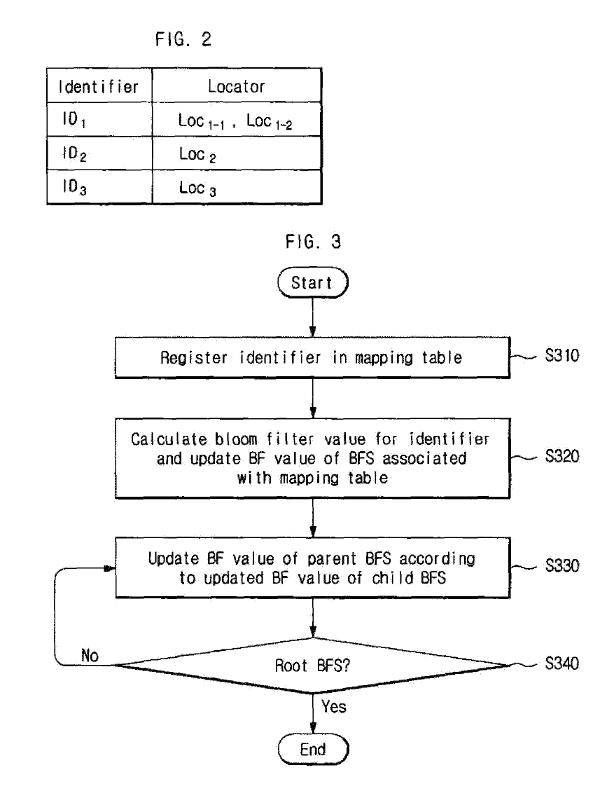

FIG. 2 illustrates an example of an identifier/locator mapping table. As illustrated, at, least one piece of locator information indicating a current location for each identifier is mapped and stored in the mapping table.

FIG. 3 is a flow diagram showing how an identifier and a locator are registered in accordance with an embodiment of the present invention.

In step S310, a new identifier and a locator indicating current location information for the identifier are registered in an identifier/locator mapping table. In an embodiment, when an identifier is generated and information corresponding to the identifier is to be registered, a mapping system corresponding to its ASN and a mapping table (or a mapping server) in which the identifier is to be registered can be determined to be bootstraps. Since it is presumed that the address of the identifier is flat (i.e. no level), it is not possible to determine in which of the leaves of the mapping system corresponding to the ASN the new identifier is to be registered. Accordingly, it is assumed that the new identifier may be registered anywhere in the mapping system.

In step S320, after the identifier is registered in the mapping table, a bloom filter value for the identifier is calculated, and a BF value of a BFS associated with the mapping table is updated.

In step S330, a BF value of a parent BFS is updated according to the updated BF value of a child BFS.

In step S340, the steps for registering the identifier are terminated if it is determined that BF values are updated all the way to a root BFS.

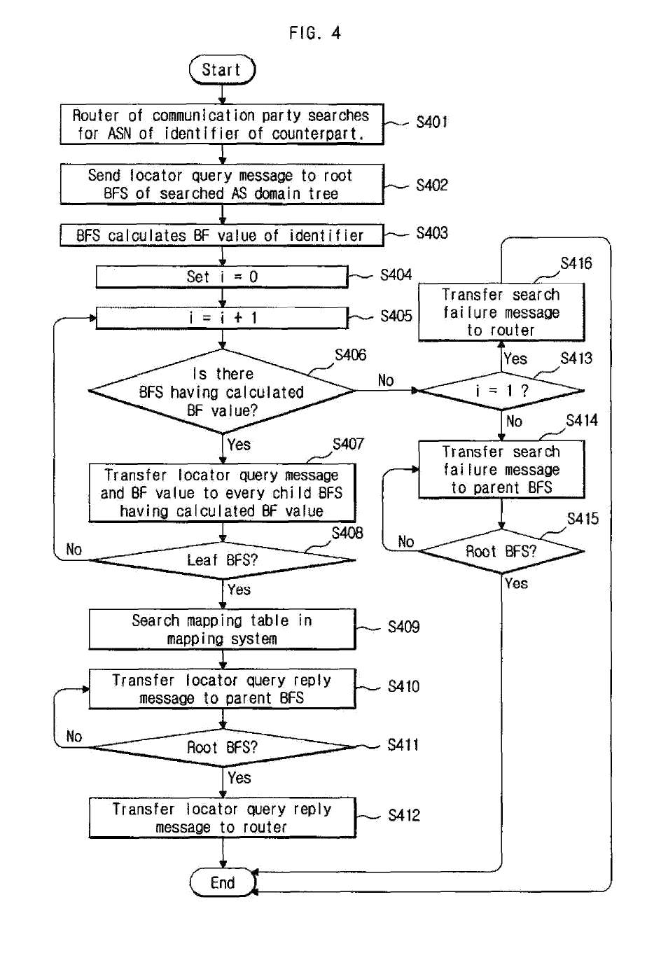

As such, the procedure for registering the identifier and the locator is carried out in a bottom-up fashion. On the other hand, the procedure for searching for the locator for the identifier is carried out in a top-down fashion. This will be described in more detail below with reference to FIG. 4.

FIG. 4 is a flow diagram illustrating the steps for searching for a locator in accordance with an embodiment of the present invention.

When communication begins, a party of the communication transmits packets with the information of a counterpart only. Then, a router executes a task of searching for a position of the counterpart.

First, in step S401, the router obtains an ASN by use of an identifier of the counterpart.

In an embodiment, the router can obtain the ASN included in header information of an identifier of the counterpart.

In step S402, a locator query message, which queries about the locator for the pertinent identifier, is sent to a root BFS of a searched AS domain mapping system.

In step 403, the root BFS having received the locator query message calculates a bloom filter value of the identifier.

In step S404, an i value is set to 0, and the i value is increased by 1 in step S405.

In step S406, it is determined whether there is a child BFS having the bloom filter value calculated in the previous step of S403.

The steps for transferring the locator query message are recursively carried out until a leaf BFS having the calculated bloom filter value is reached (S405-S408).

Once the locator query message is transferred all the way to the leaf BFS having the calculated bloom filter value, the leaf BFS searches a mapping table associated therewith and obtains locator information for the identifier (S409).

A reply message having the searched locator information included therein is transferred to a parent BFS of the leaf BFS having the calculated bloom filter value, and this step is recursively carried out until the reply message reaches the root BFS (S410-S411).

The root BFS having received the locator information transfers a locator reply message to the router that has queried about the locator information (S412).

Meanwhile, if it is determined in step S406 that there is no BF value for the pertinent identifier in the child BFS, the i value is checked. If i equals to 1, the root BFS transfers a search failure message to the router (S416) because it means that the search has failed in the root BFS. On the other hand, if the i value is anything other than 1, it means that the search has failed in a sub BFS of the root BFS, and a search failure message is transferred to the parent BFS of the sub BFS to have the search failure message reached to the root BFS (S414 and S415).

According to the above-described structure of mapping system of the present invention, the structure of the mapping system is not changed even if location information registered for the identifier is changed, and mapping table information of the mapping server having the location information of the pertinent identifier needs to be only changed. Therefore, mobility can be readily supported.

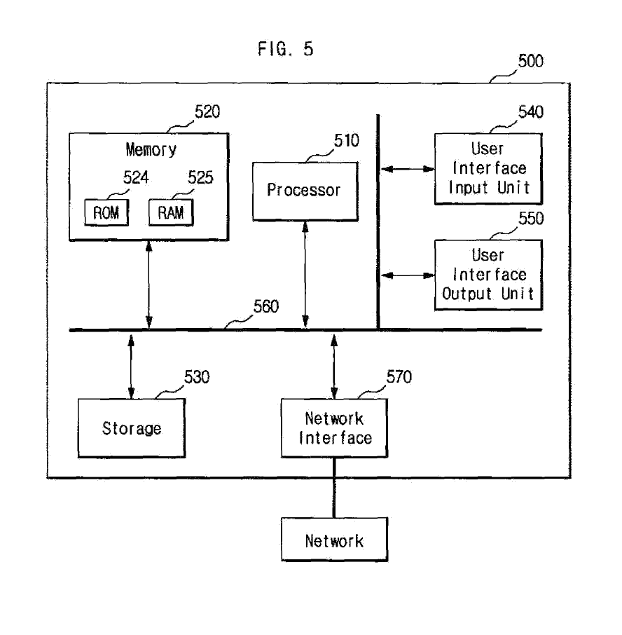

FIG. 5 is a block diagram showing the configuration of a computing system for realizing a BFS server constituting the mapping system of the present invention. An embodiment of the present invention can be implemented as, for example, a computer-readable recording medium, in a computer system.

As shown in FIG. 5, a computer system 500 may include one or more of a processor 510, a memory 520, a storage 530, a user interface input unit 540, and a user interface output unit 550, each of which communicates through a bus 560. The computer system 500 may also include a network interface 570 that is coupled to a network. The processor 510 may be a central processing unit (CPU) or a semiconductor device that executes processing instructions stored in the memory 520 and/or the storage 530. The memory 520 and the storage 530 may include various forms of volatile or non-volatile storage media. For example, the memory may include a read-only memory (ROM) 524 and a random access memory (RAM) 525.

Accordingly, an embodiment of the invention may be implemented as a computer implemented method or as a non-transitory computer readable medium with computer executable instructions stored thereon. In an embodiment, when executed by the processor, the computer readable instructions may perform a method according to at least one aspect of the invention.

The program instructions stored in the computer readable medium can be designed and configured specifically for the present invention or can be publically known and available to those who are skilled in the field of software. Examples of the computer readable medium can include magnetic media, such as a hard disk, a floppy disk and a magnetic tape, optical media, such as CD-ROM and DVD, magneto-optical media, such as a floptical disk, and hardware devices, such as ROM, RAM and flash memory, which are specifically configured to store and run program instructions. Moreover, the above-described media can be transmission media, such as optical or metal lines and a waveguide, which include a carrier wave that transmits a signal designating program instructions, data structures, etc. Examples of the program instructions can include machine codes made by, for example, a compiler, as well as high-language codes that can be executed by an electronic data processing device, for example, a computer, by using an interpreter.

The above hardware devices can be configured to operate as one or more software modules in order to perform the operation of the present invention, and the opposite is also possible.

Hitherto, certain embodiments of the present invention have been described, and it shall be appreciated that a large number of permutations and modifications of the present invention are possible without departing from the intrinsic features of the present invention by those who are ordinarily skilled in the art to which the present invention pertains. Accordingly, the disclosed embodiments of the present invention shall be appreciated in illustrative perspectives, rather than in, restrictive perspectives, and the scope of the technical ideas of the present invention shall not be restricted by the disclosed embodiments. The scope of protection of the present invention shall be interpreted through the claims appended below, and any and all equivalent technical ideas shall be interpreted to be included in the claims of the present invention.

What is claimed is:

1. A system for mapping an identifier with a locator based on a bloom filter, comprising:
a plurality of bloom filter servers (BFSs) connected with one another in a tree structure; and
an identifier/locator mapping table associated with each of a plurality of leaf BFSs located at a lower end of the tree structure,
wherein each of the leaf BFSs comprises a bloom filter indicating identifier information that is stored in the identifier/locator mapping table associated with the leaf BFS,
wherein each of remaining BFS, except for the leaf BFSs, comprises a bloom filter for a child BFS, and
wherein, once a locator query message for an identifier is received, a parent BFS recursively searches the bloom filter for the child BFS and transfers the locator query message to the leaf BFS associated with the identifier/locator mapping table having locator information for the identifier stored therein.

2. The system of claim 1, wherein the system is generated for each of autonomous system (AS) domains.

3. The system of claim 1, wherein the locator query message for the identifier is initially received by a root BFS of the tree structure from a router.

4. The system of claim 1, wherein the identifier is a flat address.

5. A method of registering an identifier and a locator in a system for mapping an identifier with a locator based on a bloom filter, the system comprising a plurality of bloom filter servers (BFSs) connected with one another in a tree structure and an identifier/locator mapping table associated with each of a plurality of leaf BFSs located at a lower end of the tree structure, the method comprising:
registering an identifier and a locator corresponding to the identifier in a designated identifier/locator mapping table;
calculating a bloom filter (BF) value for the identifier and updating a BF value of a leaf BFS associated with the identifier/locator mapping table; and
updating a BF value of a parent BFS recursively according to the updated BF value of the leaf BFS until a BF value of a root BFS is updated.

6. A method of registering an identifier and a locator in a system for mapping an identifier with a locator based on a bloom filter, the system comprising a plurality of bloom filter servers (BFSs) connected with one another in a tree structure and an identifier/locator mapping table associated with each of a plurality of leaf BFSs located at a lower end of the tree structure, the method comprising:
receiving a locator query message querying about a locator of an identifier from a router, the locator query message being received by a root BFS of the tree structure;
calculating a bloom filter value of the identifier, the bloom filter value being calculated by the root BFS having received the locator query message;
transferring the locator query message by searching a child BFS having the calculated bloom filter value;
transferring a reply message having locator information for the identifier included therein to a parent BFS from the child BFS having the calculated bloom filter value; and
receiving the reply message and transferring the reply message to the router, the reply message being received and transferred by the root BFS.

7. The method of claim 6, wherein the system for mapping an identifier with a locator based on a bloom filter is generated for each of autonomous system (AS) domains.

8. The method of claim 7, further comprising obtaining an autonomous system number (ASN) included in a header of the identifier and transferring the locator query message to a mapping system corresponding to the ASN, the ASN being obtained and the locator query message being transferred by the router.

9. The method of claim 6, wherein the transferring of the locator query message by searching a child BFS having the calculated bloom filter value is recursively carried out until the locator query message is transferred to a leaf BFS having the bloom filter value.

10. The method of claim 9, wherein, once the locator query message is transferred to the leaf BFS having the bloom filter value, the leaf BFS searches an identifier/locator mapping table associated therewith and obtains locator information corresponding to the identifier.

11. The method of claim 6, the transferring of a reply message having locator information for the identifier included therein to a parent BFS from the child BFS having the calculated bloom filter value is recursively carried out until the reply message is transferred to the root BFS.
